(19) United States
(12) Patent Application Publication
(10) Pub. No.: US 2006/0161670 A1
(43) Pub. Date: Jul. 20, 2006

(54) Communication system, computer comprising a peer-to-peer message filter and method for processing a peer-to-peer message

(76) Inventors: Frank-Uwe Andersen, Berlin (DE); Michael Finkenzeller, Munich (DE); Jochen Grimminger, Munich (DE)

Correspondence Address: STAAS & HALSEY LLP, SUITE 700, 1201 NEW YORK AVENUE, N.W., WASHINGTON, DC, 20005, US

(21) Appl. No.: 10/563,939

(22) PCT Filed: Jun. 30, 2004
(86) PCT No.: PCT/EP04/51297

§ 371 Date: Jan. 10, 2006

(30) Foreign Application Priority Data
Jul. 10, 2003 (DE) 103 31 305.2

(51) Int. Cl. G06F 15/16

(52) U.S. Cl. 709/230; 709/232

(57) ABSTRACT

Peer-to-peer messages supplied from a mobile radio communication network to a peer-to-peer message filter are detected and are supplied to a superpeer computer which is connected to a mobile radio network/fixed network interface computer. The peer-to-peer message filter is disposed in the mobile radio communication network.

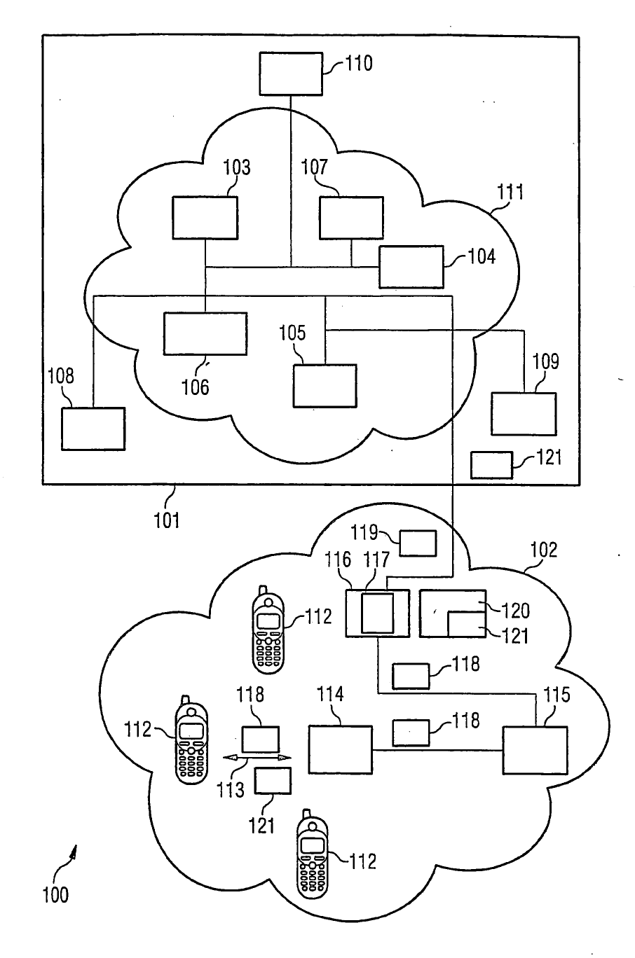

### CROSS REFERENCE TO RELATED APPLICATIONS

This application is based on and hereby claims priority to PCT Application No. PCT/EP2004/051297 filed on Jun. 30, 2004 and German Application No. 10331305.2 filed on Jul. 10, 2003, the contents of which are hereby incorporated by reference.

### BACKGROUND OF THE INVENTION

The invention relates to a communication system, a computer comprising a peer-to-peer message filter and a method for processing a peer-to-peer message.

It is known that peer-to-peer services are provided by computers connected to one another by a fixed-network communication network. In pure peer-to-peer services in which no index-server computer is used, as for example in the case of the peer-to-peer architecture Gnutella, problems arise in terms of performance and scaling in the tracing and distributing of contents to the computers connected to one another via the fixed-network communication network.

For this reason, in a fixed-network communication network superpeer computers (also often called “search hubs”, “SuperNodes” or “UltraPeers”) have been used which in terms of their performance, i.e. their computing capacity, and in data storage as regards the storable volume of data, are superior to “normal” peer-to-peer computers. The architecture in which the superpeer computers are used within the framework of peer-to-peer services is also called a hybrid peer-to-peer computer architecture.

Within the framework of the hybrid peer-to-peer computer architecture, it is known for mechanisms to be used, by which a “normal” peer-to-peer computer is selected as a superpeer computer within a hybrid peer-to-peer service using the performance data of a peer-to-peer host computer, i.e. of a computer on which a peer-to-peer service is installed. Used as performance data are, for example, the computing capacity of the central processing unit (CPU), the available bandwidth of the communication interface or communication link to which the peer-to-peer computer is connected and the memory space available in the peer-to-peer computer.

According to the related art, the superpeer computers are available only in the fixed-network communication network. Communication in the fixed-network communication network is normally effected in accordance with the Internet Protocol (IP) and the Transport Control Protocol (TCP) or else the User Datagram Protocol (UDP), as well as in accordance with the peer-to-peer protocol assigned to the peer-to-peer service being used in each case.

If, within the framework of packet-switched communication with a mobile radio terminal, a peer-to-peer service is to be used by the mobile radio terminal, then the performance of a peer-to-peer service used by said mobile radio terminal depends essentially on the point at which a superpeer computer associated with the respective service is disposed within the fixed-network communication network. In peer-to-peer-service data traffic which has been generated by a mobile radio terminal, the data packets of the data traffic must, for example in the case of GPRS (General Packet Radio Service), always be routed via the GGSN computer (gateway GPRS support node computer) until they enter the IP-based fixed-network communication network, and, in the most unfavorable case, return again into a mobile radio communication network.

For this procedure, considerable resources are needed, both in terms of the computing power of the computers involved and in terms of the available bandwidth of the fixed-network communication network and of the mobile radio communication network, which may possibly result in the impairment of other data traffic or of other voice traffic within the mobile radio communication network.

The fundamental principle of determination and disposal of superpeer computers in a fixed-network communication network is for example known in architectures such as FastTrack or the Gnutella Reflector.

In the case of FastTrack, “normal” peer-to-peer computers are dynamically selected on the basis of their better network connection relative to other peer-to-peer computers, i.e. a greater available bandwidth, or the greater computing capacity available, to be an index-server computer (superpeer computer) for the entire peer-to-peer communication network.

Under the Gnutella architecture, a reflector computer is installed at an input to a generally more poorly connected modem-sub-communication network, which reflector computer bundles inquiries/messages from the rest of the Internet-based communication network transparently for the user and, if possible, replies to them directly. The reflector computer also takes over the buffering of data which is requested very frequently, in other words, of popular content so that the load on peer-to-peer computers which have only a low-rate communication link at their disposal is reduced.

Such a reflector computer is generally installed at network transition points such as, for example, in intranet/Internet gateway computers.

### SUMMARY OF THE INVENTION

One Possible object of the invention is to improve the availability of Internet-based peer-to-peer services within a mobile radio communication network.

To address this and/or different objects, the inventors propose a computer comprising a peer-to-peer message filter, and a method for processing a peer-to-peer message.

A communication system has a fixed-network communication network, a mobile radio communication network and a mobile radio network/fixed network interface computer designed as a connecting node between these communication networks, which mobile radio network/fixed network interface computer is connected to the fixed-network communication network and the mobile radio communication network, the mobile radio network/fixed network interface computer being configured as a GGSN computer (gateway GPRS support node computer). The mobile radio network/fixed network interface computer is configured for mapping an incoming data stream from the fixed-network communication network to the communication protocol used in the mobile radio communication network and for mapping an incoming data stream from the mobile radio communication network to the communication protocol used in the fixed-network communication network. Furthermore, a superpeer computer is provided which is connected to the mobile radio network/fixed network interface computer. Also disposed in the mobile radio communication network is a peer-to-peer message filter which is configured such that peer-to-peer messages supplied from the mobile radio communication network to the peer-to-peer message filter are detected and supplied to the superpeer computer. According to one embodiment, it is provided that communication from the fixed-network communication network is also effected using the peer-to-peer message filter, in which case the peer-to-peer message filter is configured such that peer-to-peer messages supplied from the fixed-network communication network to the peer-to-peer message filter are detected and supplied to a computer in the mobile radio communication network.

A computer comprising a peer-to-peer message filter, which computer is disposed in the mobile radio communication network, is configured such that peer-to-peer messages supplied from a mobile radio communication network to said computer are detected and can be supplied to a superpeer computer which is connected to the computer comprising the peer-to-peer message filter.

In a method for processing a peer-to-peer message, a mobile radio peer-to-peer message is detected and the mobile radio peer-to-peer message is transmitted to a superpeer computer connected to a mobile radio network/fixed network interface computer and is processed by this superpeer computer. The detection of the mobile radio peer-to-peer message is effected by a computer having a peer-to-peer message filter which is disposed in a mobile radio communication network.

The inventors propose that Internet-based peer-to-peer messages are detected in the mobile radio communication network or at least directly at or from the point of view of the message flow very near to the mobile radio communication network and in that they are forwarded to a superpeer computer disposed very near to the computer comprising the mobile radio network/fixed network interface.

The expression “near” is to be understood in this context to mean that the superpeer computer, i.e. a computer comprising a superpeer functionality, is connected to the mobile radio network/fixed network interface computer by a communication link comprising a large available bandwidth, in other words, by an optimized communication link, for example in the immediate proximity of the mobile radio network/fixed network interface computer, preferably by a direct connection with no intermediate connection of a further switching computer, with a dedicated connection to the Internet-based fixed-network communication network.

The computer comprising a peer-to-peer message filter and preferably also the superpeer computer are disposed in the mobile radio communication network and are administered and operated by the mobile radio communication network operator.

The superpeer computer is preferably disposed in the mobile radio communication network, where a third-generation mobile radio network, for example, is used, in the core network of the mobile radio communication network.

Where a third-generation mobile radio communication protocol is used, for example in accordance with the GPRS or the UMTS standard, the superpeer computer is addressable by an SGSN computer (serving GPRS support node computer) or a GGSN computer (gateway GPRS support node computer).

The data traffic occurring in the core network of the mobile radio communication network on the basis of peer-to-peer messages frequently forwarded via a plurality of peer-to-peer computers is relieved by the early termination of peer-to-peer data traffic. The early termination can be ascribed in particular to the immediate proximity of the superpeer computer to the mobile radio network/fixed network interface computer.

Furthermore, the support of different peer-to-peer services is optimized in terms of the required bandwidth and the required computing capacity of a superpeer computer.

Furthermore, the response times to peer-to-peer search inquiries/messages are shortened and the requested data is available quickly to the mobile radio terminal requesting the data, as a result of which the quality of service for a user of peer-to-peer services from a mobile communication terminal is improved.

Furthermore, through the selective offer relating to the use of own superpeer computers, the attractiveness and additional earnings opportunities are increased for mobile radio communication network operators.

The embodiments described hereinbelow relate both to the communication system, to the computer comprising a peer-to-peer message filter and to the method for processing a peer-to-peer message.

According to one embodiment, the fixed-network communication network is based on Internet protocols, i.e. in particular on the Internet Protocol (IP) and the Transport Control Protocol (TCP) or else on the User Datagram Protocol (UDP).

The superpeer computer is preferably disposed in the mobile radio communication network.

This embodiment enables the message paths of peer-to-peer request messages which are sent from a mobile radio terminal to be further shortened and prevent a situation whereby a considerable data stream is routed into the fixed-network communication network, and only after transmission via a plurality of switching computers and fixed-network peer-to-peer computers a superpeer computer detected there which can process the peer-to-peer request messages.

The mobile radio communication network is based according to one embodiment on a third- or subsequent-generation mobile radio system, in particular on one of the following mobile radio communication networks:

Universal Mobile Telecommunications System (UMTS),

Future Public Land Mobile Telephone System (FPLMTS).

According to another embodiment, it is envisaged that the mobile radio communication network be configured according to the Groupe Speciale Mobile (GSM) standard.

In the event that a gateway support node computer (GGSN computer) is provided in the mobile radio network as a mobile radio network/fixed network interface computer, preferably in the event that the mobile radio communication network is configured as a UMTS communication network, communication from the mobile radio communication network to the fixed-network communication network and vice versa is effected by the GGSN computer.

According to another embodiment, an installation mechanism is provided with which a peer-to-peer service is installed in the superpeer computer if the corresponding peer-to-peer service has been requested sufficiently frequently by mobile radio terminals.

The frequency with which a peer-to-peer service is requested from a mobile radio terminal can be detected by a counter provided for a respectively offered peer-to-peer service in the superpeer computer or in the computer comprising a peer-to-peer message filter. In the event that the peer-to-peer service has been requested more frequently than a predetermined threshold provides for, the respective peer-to-peer service is installed in the superpeer computer, hereinafter also called a superpeer host computer, unless it has in any case already been installed in this computer. It should be noted in this context that multiple superpeers can be installed on the same superpeer host computer and can consequently run there.

In an alternative embodiment, it is provided that the respective counter of the peer-to-peer services be reset after a predetermined period of time so that a request rate is used as an installation criterion for the respective peer-to-peer service, in other words, a peer-to-peer service is installed in the superpeer computer if, in a predetermined time interval, more peer-to-peer requests from the mobile radio terminals in the mobile radio communication network are requested from the superpeer computer than a predetermined threshold provides for.

### BRIEF DESCRIPTION OF THE DRAWINGS

These and other objects and advantages of the present invention will become more apparent and more readily appreciated from the following description of the preferred embodiments, taken in conjunction with the accompanying drawing of which:

An exemplary embodiment is shown schematically in the FIGURE.

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

The FIGURE shows a communication system 100 comprising a fixed-network communication network 101 and a mobile radio communication network 102.

A plurality of computers 103, 104, 105, 106, 107, 108, 109, 110 are provided in the fixed-network communication network which are connected to one another by the fixed-network communication network 101 and which, in accordance with this exemplary embodiment, use the Internet Protocol (IP) and the Transport Control Protocol (TCP) for communication, in other words, the fixed-network communication network 101 is based on Internet protocols.

Furthermore, peer-to-peer services are installed in the fixed-network computers 103, 104, 105, 106, 107 in a freely predeterminable manner and the fixed-network computers 103, 104, 105 are additionally configured for communicating in accordance with the respective peer-to-peer communication protocol so that they can provide and make use of peer-to-peer services.

In the fixed-network computers 103, 104, 105, there are provided, for example, file-sharing services or else services for supplying files, for example multimedia files, especially audio files and/or video files and/or image files, according to this exemplary embodiment audio files which contain telephone ringtones. The multimedia files supplied by the respective fixed-network computer 103, 104, 105 to other peer-to-peer computers are also stored in the fixed-network computers 103, 104, 105.

Peer-to-peer services are preferably used in accordance with the peer-to-peer communication protocol Gnutella or the peer-to-peer communication protocol FastTrack. If FastTrack is used as a peer-to-peer communication protocol, then the peer-to-peer services based upon this protocol—Imesh, Grokster or KaZaA—are supplied, for example.

Also provided in the fixed-network communication network 101 are superpeer computers 106, 107 which have superpeer functionality for some or all of the peer-to-peer services available in the network, that is, serve, for example, as an index server for a respective peer-to-peer service.

The fixed-network computers 103, 104, 105 and the fixed-network superpeer computers 106, 107 form a so-called generic peer-to-peer network 111, in other words a virtual network of computers which can communicate with one another in accordance with the respective peer-to-peer service or the respective peer-to-peer communication protocol.

A plurality of mobile radio terminals 112 are provided in the mobile radio communication network 102 which are likewise configured for supplying or using peer-to-peer services.

The mobile radio terminals 112 are connected via a radio link 113 to a base station 114 and by this base station to an SGSN computer 115 and via this SGSN computer to a GGSN computer 116 so that the mobile radio terminals 112 can exchange messages with the GGSN computer 116 in accordance with the mobile radio protocol used in each case.

The mobile radio communication network (102) is configured in accordance with the UMTS standard.

According to this exemplary embodiment, the GGSN computer 116 serves as a mobile radio network/fixed network interface computer and is configured on the one hand for mapping a data stream incoming from the fixed-network communication network 101 to the communication protocol used in the mobile radio communication network 102 and on the other for mapping a data stream incoming from the mobile radio communication network 102 to the communication protocol used in the fixed-network communication network 101 or its data formats. Furthermore, a peer-to-peer message filter 117 is provided in the GGSN computer 116 which can detect peer-to-peer messages in the message stream which is incoming into the GGSN computer 116.

This is effected, for example, such that the peer-to-peer request message 118 supplied to the GGSN computer 116 from a mobile radio terminal 112 is supplied and unpacked in the UMTS protocol format, generally in the 3GPP protocol format used in each case, i.e. is decoded so that the peer-to-peer request message is detected in the GGSN computer 116 at the protocol level of OSI layer 7, i.e. the application layer, in accordance with the peer-to-peer communication protocol format used in each case.

Alternatively, the specification of the port via which the peer-to-peer request message 118 has been received from the GGSN computer 116 can be used as an identification criterion, since a port number is normally assigned unambiguously to a peer-to-peer service.

If the peer-to-peer request message 118 is decoded, then the GGSN computer uses a mapping table in which all peer-to-peer protocol formats considered by the peer-to-peer message filter 117 are specified in order to determine by comparing the protocol formats whether and, if so, which peer-to-peer protocol format was used in the message and which peer-to-peer service was requested in the peer-to-peer request message 118.

If the GGSN computer 116 can detect the respective peer-to-peer service, then it forwards the decoded peer-to-peer request message 119 to a superpeer hosting server computer 120 connected to the GGSN computer 116. The superpeer hosting server computer 120 is likewise disposed in the mobile radio communication network 102. The superpeer hosting server computer 120 receives the decoded peer-to-peer request message 119 and determines whether it can itself provide the peer-to-peer service requested in the peer-to-peer request message 119 or not. According to this exemplary embodiment, a certain telephone ringtone is requested by the mobile radio terminal 112 in the request message 119.

In the simplest case, it is provided that the request message 118 is not modified at all, but is only unpacked, which take place in any case in the GGSN computer 116. This means that in this case the peer-to-peer request message 119 is a message sent using IP with the destination address of a random neighboring peer.

In this case, the superpeer hosting server computer 120 is nothing but a simple IP router computer, with the difference that—as mentioned above—a counter mechanism is running which ensures that, upward of a certain popularity of a service, a superpeer instance of the respective peer-to-peer service is installed on the superpeer hosting server computer 120.

If an unmodified version of a peer-to-peer file-sharing program is installed on the mobile communication terminal, it is hardly useful to achieve a situation where these request messages are processed efficiently in the peer-to-peer message filter 117 or the superpeer hosting server computer 120 without the peer-to-peer message filter 117 or the superpeer hosting server computer 120 already being configured such that it understands a basic variant of the peer-to-peer communication protocol used, i.e. can process this protocol. In this case, it should, depending on the peer-to-peer communication protocol used, be ensured that

1. a superpeer instance of the respective peer-to-peer service is installed (see above) and

2. this superpeer is acquainted with the IP address of the superpeer hosting server computer 120 and/or the mobile terminals 112. The procedure is in this case protocol-dependent.

Provided that the superpeer selection algorithm of a certain peer-to-peer communication protocol is sufficiently intelligent, then after a certain time the superpeer is automatically found in the superpeer hosting server computer 120 and made known to the mobile subscribers 112. From this moment on, the request messages 119 will always be addressed to the superpeer hosting server computer 120.

In aggregate, there are thus the following tasks for the peer-to-peer message filter 117:

1. detection of the popularity of a peer-to-peer service;

2. upward of a certain popularity of a peer-to-peer service, initiation of installation of a superpeer instance of this peer-to-peer service on the superpeer host computer 120;

3. optionally, rejection of all messages which are not addressed to a superpeer instance in own network, as explained in detail below.

As described above, the peer-to-peer protocol messages are already addressed to “random” IP addresses of “known” peers of a peer-to-peer service. The peer-to-peer software determines these known peers either with the aid of so-called rendezvous server computers, which provide a list of “active” peers, or from preconfigured addresses (configuration file) or from a manual input by a user.

These three options also provide the starting points for involving an own superpeer.

The parsing and manipulation of messages which are not addressed to the own superpeer is very costly and is appropriate only in exceptional cases.

Such an exceptional case is provided by redirector instances. These are protocol-specific and roughly comparable with a rendezvous server computer. They are also addressed directly by peer-to-peer software on the terminal, but can, through certain messages (protocol-specific), cause the peers to consider superpeers.

The following options, among others, thus emerge for involving an own superpeer:

Rely on the intelligence of the protocol (automatic).

Supply rendezvous server computer with IP of own superpeer.

Provide modified versions of peer-to-peer software which already contain the address of own superpeer.

Make available on own website the address of own superpeer for the manual configuration of peer-to-peer software for downloading.

With the aid of redirector instances of a peer-to-peer service or with peer-to-peer protocol messages which allow a redirect to draw the attention of the peer-to-peer software to the own superpeer.

The filter rejects all messages not addressed to the superpeer. However, this functions only when linked with a method stated above for notifying the terminals of own superpeer.

If the corresponding peer-to-peer service is installed in the superpeer hosting server computer 120, then it provides the requested peer-to-peer service and communicates to the GGSN computer 112 the result of the requested peer-to-peer service in a peer-to-peer response message 121. The peer-to-peer response message 121 is transmitted to the mobile radio terminal 112 sending the peer-to-peer request message 119. The multimedia file specified in the peer-to-peer request message 119 can then, according to this exemplary embodiment with the desired telephone ringtone, be read out from the memory of the peer-superpeer hosting server computer 120 and sent to the mobile radio terminal 112 or else be loaded from the respective peer-to-peer server.

In this case, it is a precondition that a previously installed and established superpeer supports a caching function and that the desired telephone ringtone has already been requested once and thus been cached, i.e. stored intermediately, on the superpeer. The data transmission can thus take place. A distinction must be made in each case between request/response messages and the actual data exchange. In the event that the data is not cached, the superpeer hosting server computer 120 provides only the information as to where in the peer-to-peer network the data is to be found. The downloading is then carried out from there.

It is in this way avoided in the above case, that a data stream enters the fixed-network communication network 101 and ties up resources there.

The requested peer-to-peer service is thus provided for the mobile radio terminal 112.

It must be pointed out in this context that, according to an alternative embodiment, the procedure described above is also provided in the other direction of communication, namely where there is a request message from the fixed-network communication network to the mobile radio communication network.

If the requested peer-to-peer service is not, however, installed in the superpeer hosting server computer 120, then the superpeer hosting server computer 120 forwards the request message 119 to the fixed-network communication network 101 (not shown), i.e. the Internet or the peer-to-peer network 111 to the other fixed-network superpeer computers 106, 107 or to the other fixed-network peer-to-peer computers 103, 104, 105 and in this way requests the peer-to-peer service for the mobile radio terminal 109 from the fixed-network computers 103, 104, 105, 106, 107. In this case, the superpeer hosting server computer 120 clearly represents an additional IP router computer.

Furthermore, a counter is provided in the superpeer hosting server computer 120 for each peer-to-peer service known in any way to it, which counter is increased by the value 1 upon receipt of a peer-to-peer request for the respective peer-to-peer service, provided the respective peer-to-peer service has not previously been installed on the superpeer hosting server computer 120.

If the counter value exceeds a predetermined threshold, then the peer-to-peer service thus achieving sufficient popularity is installed on the superpeer hosting server computer 120 and configured manually, preferably automatically, by an installation mechanism.

Upon installation of the respective peer-to-peer service on the superpeer hosting server computer 120, the service to be installed is configured in a manner and equipped with resources, for example with sufficient computing capacity, with a sufficiently fast communication link to the fixed-network communication network, i.e. one equipped with a sufficiently large bandwidth, and with sufficient memory, that the instance of the respective peer-to-peer service rises within the peer-to-peer network as a whole to become a superpeer computer.

In this context, upon installation of the peer-to-peer service on the superpeer hosting server computer 120, the service is published on correspondingly provided World Wide Web pages of a peer-to-peer service or an entry is made on rendezvous server computers or in host caches.

The mobile radio terminals 112 that want to use a certain peer-to-peer service can also, preferably also automatically, be informed about the existence of a superpeer instance for the respective peer-to-peer service in the provider's own mobile radio communication network and be configured correspondingly.

A superpeer computer is connected as optimally as possible to a mobile radio communication network or is already disposed in the mobile radio communication network 102 itself and operated by the mobile radio network provider, so that peer-to-peer request messages sent from a mobile radio terminal 109 are not transmitted into the entire, principally fixed-network-based, peer-to-peer network 111 but the messages are terminated as early as possible, thereby reducing the data traffic that occurs.

It should be noted in this context that the method and system are applicable both to peer-to-peer architectures comprising two hierarchical levels and to hybrid peer-to-peer architectures equipped with any number of additional hierarchical levels.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A communications system comprising:
a fixed-network communication network;
a mobile radio communication network;
a mobile radio network/fixed network interface computer which is connected to the fixed-network communication network and to the mobile radio communication network for mapping a data stream between the fixed-network communication network and the mobile radio communication network;
a superpeer host computer which is connected to the mobile radio network/fixed network interface computer; and
a peer-to-peer message filter, provided in the mobile radio communication network, the peer-to-peer message filter being supplied with peer-to-peer messages from the mobile radio communication network, the peer-to-peer message filter detecting the peer-to-peer messages and supplying the peer-to-peer messages to the superpeer host computer.

12. The communication system according to claim 11, wherein the fixed-network communication network operates based on an Internet protocol.

13. The communication system according to claim 11, wherein the superpeer host computer is part of the mobile radio communication network.

14. The communication system according to claim 11, wherein the mobile radio communication network is a third- or subsequent-generation mobile radio system.

15. The communication system according to claim 14, wherein the mobile radio communication network operates according to one of the following mobile radio communication platforms:
Universal Mobile Telecommunications System (UMTS), and
Future Public Land Mobile Telephone System (FPLMTS).

16. The communication system according to claim 11, wherein the mobile radio communication network operates in accordance with Groupe Speciale Mobile (GSM) platform.

17. The communication system according to claim 15, wherein
the mobile radio communication network operates based on the Universal Mobile Telecommunications System (UMTS)platform, and
the mobile radio network/fixed network interface computer is a Gateway GPRS Support Node (GGSN) computer.

18. The communication system according to claim 11, further comprising an installation mechanism to trigger installation of peer-to-peer service in the superpeer computer when the frequency of demand for the peer-to-peer service reaches a threshold value.

19. The communication system according to claim 12, wherein the superpeer host computer is part of the mobile radio communication network.

20. The communication system according to claim 19, wherein the mobile radio communication network is a third- or subsequent-generation mobile radio system.

21. The communication system according to claim 20, wherein the mobile radio communication network operates according to one of the following mobile radio communication platforms:
Universal Mobile Telecommunications System (UMTS), and
Future Public Land Mobile Telephone System (FPLMTS).

22. The communication system according to claim 19, wherein the mobile radio communication network operates in accordance with Groupe Speciale Mobile (GSM) platform.

23. The communication system according to claim 21, wherein
the mobile radio communication network operates based on the Universal Mobile Telecommunications System (UMTS)platform, and
the mobile radio network/fixed network interface computer is a Gateway GPRS Support Node (GGSN) computer.

24. The communication system according to claim 23, further comprising an installation mechanism to trigger installation of peer-to-peer service in the superpeer computer when the frequency of demand for the peer-to-peer service reaches a threshold value.

25. A computer for peer-to-peer message communication between a mobile radio network and a fixed network communication network, comprising:
a peer-to-peer message filter to receive peer-to-peer messages from the mobile radio communication network, detect the messages and supply the messages to a superpeer computer; and
mapping means to map peer-to-peer messages between the mobile radio network and the fixed network communication network.

26. A method for processing a peer-to-peer message in a communication system comprising:
detecting a mobile radio peer-to-peer message with a computer comprising a peer-to-peer message filter disposed in a mobile radio communication network;
mapping the mobile radio peer-to-peer message to a protocol used in a fixed network;
transmitting the mobile radio peer-to-peer message to a superpeer computer connected to a mobile radio network/fixed network interface computer; and
processing the mobile radio peer-to-peer message by the superpeer computer.
